(19) United States
(12) Patent Application Publication
(10) Pub. No.: US 2010/0330491 A1
(43) Pub. Date: Dec. 30, 2010

(54) ELECTROSTATIC CHARGE IMAGE DEVELOPING TONER

(75) Inventors: Kouji SUGAMA, Tokyo (JP); Masahiko NAKAMURA, Tokyo (JP); Masahiro ANNO, Tokyo (JP); Shiro HIRANO, Tokyo (JP); Junya ONISHI, Tokyo (JP); Tatsuya FUJISAKI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/816,598

(22) Filed: Jun. 16, 2010

(30) Foreign Application Priority Data
Jun. 29, 2009 (JP) 2009153564

(51) Int. Cl. G03G 9/08

(52) U.S. Cl. 430/108.11

(57) ABSTRACT

Provided is an electrostatic charge image developing toner producing neither halftone image unevenness nor density drop of solid images, even though a large number of print sheets are printed at high temperature and high humidity, and subsequently printing is further carried out at high temperature and high humidity after standing for a long time. Disclosed is an electrostatic charge image developing toner containing 3-10% by weight of at least one metal fluoride selected from the group consisting of sodium fluoride, magnesium fluoride, calcium fluoride, barium fluoride and aluminum fluoride, based on a total weight of the toner.

This application claims priority from Japanese Patent Application No. 2009-153564 filed on Jun. 29, 2009, which is incorporated hereinto by reference.

### TECHNICAL FIELD

The present invention relates to an electrostatic charge image developing toner.

### BACKGROUND

In recent years, chances to use a printer and a digital complex machine for which an electrographic system is utilized have been increased in an office region as well as a production printing market. In the case of the production printing market, a stably high quality images exhibiting reduced environmental variation over a long duration have increasingly been demanded more in the production printing market than in the office region.

In order to achieve the demand of the high quality images, disclosed is an emulsion association type toner formed by coagulating/fusing resin particles and colorants in an aqueous medium (refer to Patent Documents 1 and 2, for example).

It is advantageous that this emulsion association type toner exhibits evenness in particle size distribution, together with easy control in toner particle diameter, and is prepared via a process suitable for realization of the small particle diameter.

Since colorants are well dispersed in toner particles to prepare the emulsion association type toner, employed is a step to increase an acidic component amount of resin particles to form toner particles.

However, there appears a drawback such that this toner exhibits high moisture absorbency at high temperature and high humidity, resulting in easy reduction of a charging amount.

Specifically, there was a problem such that when a large number of print sheets were printed at high temperature and high humidity, and printing was carried out after standing for a long time at high temperature and high humidity, image troubles such as halftone image unevenness and density drop of solid images were produced.

(Patent Document 1) Japanese Patent O.P.I. Publication No. 2003-66648

(Patent Document 2) Japanese Patent O.P.I. Publication No. 11-194540

### SUMMARY

It is an object of the present invention to provide an electrostatic charge image developing toner exhibiting neither halftone image unevenness nor density drop of solid images, even though a large number of print sheets are printed at high temperature and high humidity, and subsequently printing is further carried out at high temperature and high humidity after standing for a long time.

### BRIEF DESCRIPTION OF THE DRAWINGS

FIG. 1 is a cross-sectional configuration diagram showing an example of an image forming apparatus employing a toner of the present invention.

### DESCRIPTION OF THE PREFERRED EMBODIMENTS

The above-described object of the present invention is accomplished by the following structures.

(Structure 1) An electrostatic charge image developing toner comprising 3-10% by weight of at least one metal fluoride selected from the group consisting of sodium fluoride, magnesium fluoride, calcium fluoride, barium fluoride and aluminum fluoride, based on a total weight of the toner.

(Structure 2) The electrostatic charge image developing toner of Structure 1, comprising a toner formed via coagulation/fusion of at least a resin in an aqueous medium.

(Structure 3) The electrostatic charge image developing toner of Structure 1 or 2, comprising a core/shell structure comprising a core portion and a shell layer, wherein the shell layer comprises the metal fluoride.

(Structure 4) The electrostatic charge image developing toner of Structure 1, wherein external additives in the toner have an addition amount of 0.05-5 parts by weight, with respect to 100 parts by weight of the toner.

(Structure 5) The electrostatic charge image developing toner of Structure 1, wherein external additives in the toner have an addition amount of 0.1-3 parts by weight, with respect to 100 parts by weight of the toner.

(Structure 6) The electrostatic charge image developing toner of Structure 1, wherein the at least one metal fluoride is magnesium fluoride or calcium fluoride.

(Structure 7) The electrostatic charge image developing toner of Structure 1, wherein the at least one metal fluoride has a content of 4-7% by weight, based on the total weight of the toner.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

There appeared a problem such that when a large number of print sheets were printed at high temperature and high humidity, and printing was carried out after standing for a long time at high temperature and high humidity, image troubles such as halftone image unevenness and density drop of solid images were produced.

Various studies have been done by the inventors in order to solve the above-described problem.

After considerable effort during intensive studies, the inventors have found out that the above-described problem is possible to be solved by containing a specific amount of at least one selected from the following metal fluoride (MFx) in toner particles.

Examples of the metal fluoride include sodium fluoride (NaF), magnesium fluoride (MgF₂), calcium fluoride (Ca F₂), barium fluoride (Ba F₂), and aluminum fluoride (Al F₃).

As preferred metal fluorides, provided can be magnesium fluoride (MgF₂) and calcium fluoride (Ca F₂) exhibiting low solubility with respect to an aqueous medium.

Metal fluorides other than those described above are not preferable because of lack of a water-repellent property.

When an appropriate amount of metal fluoride MFx is contained in toner particles, a water-repellent property of toner is enhanced. As a result, moisture absorbency of the toner can be suppressed to be lowered to obtain a toner exhibiting excellent moisture absorbency resistance and small variation in charging amount, without producing image failure such as halftone image unevenness and density drop of solid images.

Specifically, as to a toner having a core/shell structure, in cases where metal fluoride is present in a shell layer coated on a core portion, a moisture content is difficult to penetrate into the inside of the toner since a water-repellent property is increased around the toner surface, whereby moisture absorbency resistance is effectively enhanced. Further, electrification of the toner can be stabilized since a moisture content on the toner surface stably tends not to undergo the environmental influence.

Metal fluoride contained in toner particles has a content of 3-10% by weight, based on the total weight of toner, and preferably has a content of 4-7% by weight

In addition, a content of metal fluoride can be determined by measuring a peak intensity of a fluorine element employing an X-ray fluorescence spectrometer (XRF) (XRF-1800, manufactured by Shimadzu Corporation), for example. Specifically, in the case of magnesium fluoride, the following procedures (1)-(3) are carried out.

(1) First, a known amount of magnesium fluoride is added into 100 parts by weight to prepare pellets for the fluorine element measurement as a sample for preparation of a calibration.
(2) Next, the resulting pellet for fluorine element measurement is analyzed via X-ray fluorescence analysis, and the calibration curve is prepared from the peak intensity obtained through each pellet as to magnesium fluoride contained in styrene powder.
(3) Thereafter, specific toner is analyzed via X-ray fluorescence analysis, the resulting peak intensity is checked out with the calibration curve to quantitate a content of magnesium fluoride. As to metal fluorides other than magnesium fluoride, the content can be similarly determined via preparation of a calibration curve. In addition, Ka peak angle of an element to be measured was determined from a 20 table, and used in this experiment. In addition, as to the conditions of the X-ray generating section, provided are a target of Rh, a tube voltage of 40 kV, a tube current of 95 mA and no filter, and as to the conditions of the spectroscopic system, provided are a standard slit, no attenuator, a dispersive crystal (F=TAP) and a detector (F=FPC). Further, metal in metal fluoride can be determined employing an apparatus in which an energy dispersive X-ray spectroscopic analyzer (EDS) (JED-2000, manufactured by JEOL Ltd.) is installed in a scanning electron microscope (SEM) (JSM-7401F, manufactured by JEOL Ltd.), for example. Specifically, element mapping of toner particle is conducted, and an element having a peak at the same place as that of a fluorine element can be determined to identify it. As to the conditions of EDS measurement, provided are an accelerating voltage of 20 kV, an exposure current of 2.56 nA and a PHA mode of T3.

When metal fluoride contained in toner particles is designed to have a content of 3% by weight or more, based on the total weight of toner, the effect to inhibit moisture absorbency is produced, and when the metal fluoride is designed to have a content of 10% by weight or less, based on the total weight of toner, the metal fluoride can be evenly dispersed in toner particles, whereby the charging amount distribution becomes even, and generation of fog can be inhibited.

The method to contain metal fluoride in toner particles is not specifically limited.

As a preferred method to contain metal fluoride in toner particles, provided is a method by which a dispersion obtained by dispersing metal fluoride is added in a step of coagulating/fusing resin particles to contain the metal fluoride in toner particles.

The number average particle diameter in a metal fluoride dispersion is preferably 20-200 nm.

This particle diameter is a value measured employing an electrophoretic light scattering photometer “ELS-800” (manufactured by Otsuka Electronics Co., Ltd.).

The method of preparing a metal fluoride dispersion is not specifically limited, but examples thereof include preparation methods by dispersing metal fluoride particles in an aqueous medium employing a medium type dispersing machines such as a sand grinder, a Gettsman mill or a diamond fine mill; an ultrasonic disperser; or a mechanical homogenizer.

In addition, also provided can be a method by which metal fluoride is mixed with a resin and a colorant via a dry process, and an admixture thereof is melted and kneaded to contain the metal fluoride in toner particles.

Next, a method of manufacturing a toner of the present invention as an example will be described.

### <<Method of Preparing Toner>>

The toner of the present invention can be prepared via the following steps, for example.

(1) A step of preparing a solution by which a releasing agent is dissolved or dispersed in a polymerizable monomer.

(2) A step of preparing core resin particles via polymerization of the polymerizable monomer.

(3) A step of coagulating/fusing the core resin particles in an aqueous medium in the presence of polyvalent metal ions to prepare core particles.

(4) A step of fusing each of shell resin particles and metal fluoride on the core particle surface via addition of the shell resin particle and the metal fluoride into a core particle dispersion to fond a toner mother particle having a core/shell structure.

(5) A step of solid-liquid separation/washing, by which the toner mother particle is solid-liquid-separated from the toner mother particle dispersion, and a surfactant or the like is removed from the toner mother particle.

(6) A step of drying toner mother particles having been washed.

(7) A step of adding external additives into the toner mother particles having been subjected to a dying treatment to prepare the toner.

Next, each of the steps will be described.

### (1) Step of Preparing a Dispersion

This step is a step of preparing a solution by which a releasing agent is dissolved or dispersed in a polymerizable monomer.

### (2) Step of Preparing Core Resin Particles

As a preferred example of this process, the above-described solution is added into an aqueous medium containing a surfactant of not more than the critical micelle concentration (CMC) to form liquid droplets via application of mechanical energy, and polymerization reaction is subsequently accelerated in the liquid droplets via addition of water-soluble radical polymerization initiator to form a resin. Incidentally, an oil-soluble polymerization initiator may be contained in the liquid droplets. In such a polymerization process, a treatment of forcibly emulsifying (formation of liquid droplets) by applying mechanical energy should be conducted. Examples of the mechanical energy-providing means include may include strongly stirring or ultrasonic vibration energy-providing devices such as a homo-mixer, ultrasonic waves, and Manton-Gaulin.

### (3) Step of Preparing Core Particles

Core resin particles and colorants are coagulated/fused in an aqueous medium in the presence of polyvalent metal ions to prepare core particles via salting-out/fusing of core resin particles-to-core resin particles. Also in the step of preparing core particles, coagulated/fused can be internal additive particles such as releasing agent particles or a charge control agent particles together with core resin particles and colorants.

In addition, “salting-out/fusing” herein means that coagulation and fusion are simultaneously generated to ion-crosslink core resin particles-to-core resin particles, and when reaching a desired particle diamete, particle growth is terminated via addition of a coagulation-terminating agent, and further, heating to control particle shape is continuously conducted, if desired.

“Aqueous medium” is referred to as one made from water as a principal component (at least 50% by weight). Here, as a component other than water, an organic solvent dissolved in water can be provided, and examples thereof include methanol, ethanol, isopropanol, butanol, aceton, methylethyl ketone, and tetrahydrofuran.

In addition, a colorant dispersion dispersed in an aqueous medium is used for the colorant. A dispersing treatment for the colorant is conducted in a state where a surfactant concentration in water is set to not less than critical micelle concentration (CMC). The dispersing apparatus to be used for a dispersing treatment for the colorant is not specifically limited, but preferable are an ultrasonic dispersing apparatus, a mechanical homogenizer, an applied pressure dispersing apparatus such as a Manton Gaulin homogenizer or a pressing type homogenizer, a sand grinder, and a medium type dispersing apparatus such as a Getzman mill or a diamond fine mill. Further, as a surfactant to be used, the same one as the foregoing surfactant can be provided.

A salting-out/coagulation method as a preferable coagulation/fusion method is performed by the following step. In the step, a salting-out agent composed of a polyvalent metal ion compound as a coagulant at a critical coagulation concentration or more is added into an aqueous medium containing core resin particles and colorant, and the system was subsequently heated to a temperature higher than the glass transition point of the foregoing core resin particles to perform salting-out concurrently with fusion.

When the coagulation/fusion is carried out via salting-out/fusion, a standing duration after addition of a salting-out agent is preferably as shortly as possible. This reason is not clear, but there appears a problem such that the coagulating state of particles is varied depending on the standing duration after salting-out, whereby a particle size distribution becomes unstable, and a surface property of the fused toner varies. Further, the temperature at which the salting-out agent is added is preferably not higher than the glass transition temperature of the core resin particles. For this reason, there appears a problem such that when the temperature at which the salting-out agent is added is a glass transition temperature of the core resin particles or higher, the salting-out/fusion of the core resin particles are smoothly accelerated, but the particle size cannot be controlled, whereby large size particles tend to be generated. The range of addition temperature may be lower than the glass transition temperature of the resin, but is generally 5-55° C., and is preferably 10-45° C.

Further, the salting-out agent is added at a temperature of not higher than the glass transition temperature of the core resin particles, and then the temperature is raised as quickly as possible to raise temperature to a temperature of a glass transition temperature of the core resin particles or higher. The period of time to raise temperature up to this temperature is preferably less than one hour. Further, temperature raising is quickly carried out, but the temperature raising rate is preferably 0.25° C./min or more. The upper limit is not specifically clear, but there is a problem such that when the temperature is immediately increased, the salting-out is rapidly developed, and the particle size is difficult to be controlled, whereby the rate is preferably 5° C./min or less. Thus, a core particle dispersion can be obtained via this fusing step.

### (4) Step of Forming Toner Mother Particles

In this step, shell resin particles and metal fluoride are fused on the core particle surface by adding the shell resin particles and the metal fluoride dispersion into a core particle dispersion to form toner mother particles.

Preferably, the shell resin particles and the metal fluoride dispersion are added into the core particle dispersion, and the shell resin particles and the metal fluoride are slowly coated on the core particle surface while continuously heating and stirring spending a few hours to form toner mother particles. A heating duration while stirring is preferably 1-7 hours, and more preferably 2-5 hours.

### (5) Step of Solid-Liquid Separation/Washing

A toner mother particle dispersion is first subjected to a cooling treatment Cooling conducted under the cooling treatment condition of a cooling rate of 1-20° C./min. The cooling treating method is not specifically limited.

The solid-liquid separation/washing step is a step subjected to a solid-liquid separation treatment to solid-liquid separate the toner mother particles from a toner mother particle dispersion having been cooled to a predetermined temperature in the above-described step, and a washing treatment to remove deposits such as the surfactant and the salting-out agent from a solid-liquid separated toner cake (an aggregation substance obtained in the form of a cake via coagulation of wet toner mother particles). Herein, the filter treatment method, which is not specifically limited, may include methods such as a centrifugal separation method, a reduced pressure filtration method using Nutsche, and a filtration method using a filter press.

### (6) Step of Drying

This step is a step in which the washed cake is subjected to a drying treatment to obtain dried toner mother particles. Drying machines usable in this step include, for example, a spray dryer, a vacuum freeze-drying machine, or a vacuum dryer. Preferably used are a standing plate type dryer, a movable plate type dryer, a fluidized-bed dryer, a rotary dryer or a stirring dryer. The moisture content of the dried toner mother particles is preferably not more than 1.0% by weight, and more preferably not more than 0.5% by weight. When toner particles having been subjected to a drying treatment are coagulated via a weak inter-particle attractive force, the aggregate may be subjected to a pulverization treatment. Pulverization can be conducted using a mechanical pulverizing device such as a jet mill, a Henschel mixer, a coffee mill or a food processor.

### (7) Step of Preparing Toner

This step is a step in which external additives are mixed in dried toner mother particles to prepare toner.

In addition, “toner” means an aggregate of toner particles. Toner mother particles may also be used as-is as toner particles, but the toner particles are preferably used as particles each in which external additives are added into the toner mother particle.

As a mixer for external additives, usable is a mechanical type mixer such as a Henschel mixer, a coffee mill, or the like.

Next, members employed for preparation of the toner of the present invention will be described.

### <Resin to Form Core Resin Particle>

Core resin particles to form core particles are formed from those prepared by polymerizing at least a polymerizable monomer having a carboxyl group and another polymerizable monomer.

Preferred examples thereof include resins obtained by copolymerizing a polymerizable monomer having a carboxyl group and another polymerizable monomer such as propyl acrylate, propyl methacrylate, butyl acrylate, 2-ethylhexyl acrylate or the like.

### <Resin to Form Shell Resin Particle>

Similarly to the core resin particles, polymerizable monomers are usable for resins to form shell resin particles.

### (Colorant)

As the colorant, carbon black, a magnetic material, a dye and a pigment are optionally usable. Usable examples of the carbon black include channel black, furnace black, acetylene black, thermal black and lamp black. Examples of the magnetic material include a ferromagnetic metal such as iron, nickel or cobalt; an alloy containing these metals; a ferromagnetic metal compound such as ferrite or magnetite; an alloy exhibiting ferromagnetism via a heat treatment though containing no ferromagnetic metal, such as an alloy called Heusler alloy, for example, a manganese-copper-aluminum alloy or a manganese-copper-tin alloy; and chromium dioxide.

Usable examples of dyes include C. I. Solvent Red 1, C. I. Solvent Red 49, C. I. Solvent Red 52, C. I. Solvent Red 58, C. I. Solvent Red 63, C. I. Solvent Red 11, C. I. Solvent Red 122, C. I. Solvent Yellow 19, C. L Solvent Yellow 44, C. I. Solvent Yellow 77, C. I. Solvent Yellow 79, C. I. Solvent Yellow 81, C. I. Solvent Yellow 82, C. I. Solvent Yellow 93, C. I. Solvent Yellow 98, C. I. Solvent Yellow 103, C. L Solvent Yellow 104, C. I. Solvent Yellow 112, C. I. Solvent Yellow 162, C. I. Solvent Blue 25, C. I. Solvent Blue 36, C. I. Solvent Blue 60, C. I. Solvent Blue 70, C. I. Solvent Blue 93, C. I. Solvent Blue 95, and their mixtures. Usable examples of pigments include C. I. Pigment Red 5, C. I. Pigment Red 48:1, C. I. Pigment Red 48:3, C. I. Pigment Red 53:1, C. I. Pigment Red 57:1, C. L Pigment Red 81:4, C. I. Pigment Red 122, C. I. Pigment Red 139, C. I. Pigment Red 144, C. I. Pigment Red 149, C. I. Pigment Red 150, C. I. Pigment Red 166, C. I. Pigment Red 177, C. I. Pigment Red 178, C. L Pigment Red 222, C. I. Pigment Red 238, C. I. Pigment Orange 31, C. I. Pigment Orange 43, C. I. Pigment Yellow 14, C.I. Pigment Yellow 17, C.I. Pigment Yellow 74, C. I. Pigment Yellow 93, C.I. Pigment Yellow 94, C. I. Pigment Yellow 138, C. I. Pigment Yellow 155, C. I. Pigment Yellow 156, C. L Pigment Yellow 158, C. L Pigment Yellow 180, C. I. Pigment Yellow 185, C. I. Pigment Green 7, C. I. Pigment Blue 15:3, C. I. Pigment Blue 60, and their mixtures. These preferably have a primary particle diameter of roughly 10 nm—roughly 200 nm, depending on kinds of these.

### (Releasing Agent)

As the releasing agent, those commonly known are usable. Preferred examples thereof include polyolefin wax such as polyethylene wax or polypropylene wax; long chain hydrocarbon wax such as paraffin wax or sasol wax; dialkylketone based wax such as distearyl ketone; ester based wax such as carnauba wax, montan wax, trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecanediol distearate, trimellitic acid tristaryl or distearyl meleate; and amide based wax such as ethylenediamine dibehenylamide or trimellitic acid tristearylamide.

The releasing agent has a melting point of 40-160° C.; preferably has a melting point of 50-120° C.; and more preferably 60-90° C. A melting point falling within the above-described range ensures heat resistant stability of the toner, and can achieve stable toner image formation without causing cold offsetting even when fixed at a relatively low temperature. The releasing agent content in the toner is preferably 1-30% by weight, and more preferably 5-20% by weight.

### (Charge Control Agent)

A charge control agent may also be contained in toner, if desired. As the charge control agent, commonly known compounds are usable.

### (External Additive)

In order to improve fluidity, electrification, and a cleaning property, external additives such as a fluidizer, a cleaning aid and so forth may also be contained in toner.

Examples of external additive particles include inorganic oxide particles such as silica particles, alumina particles, titanium oxide particles and so forth; inorganic stearic acid compound particles such as aluminum stearate particles, zinc stearate particles and so forth; or inorganic titanic acid compound particles such as strontium titanate, zinc titanate and so forth. These inorganic particles preferably have a number average primary particle diameter of 10-1000 nm, and more preferably have a number average primary particle diameter of 10-3000 nm. These can be used singly or in combination with at least 2 kinds.

Spherical organic particles having a number average primary particle diameter of roughly 10-2000 nm are also usable as the external additives. Polystyrene, polymethyl methacrylate, a styrene-methyl methacrylate copolymer and so forth are usable as such the organic particles.

External additives thereof have an addition amount of 0.05-5 parts by weight, with respect to 100 parts by weight of the toner, and preferably have an addition amount of 0.1-3 parts by weight, with respect to 100 parts by weight of the toner. In addition, the external additives may be used in combination with various kinds.

### <<Developer>>

The toner of the present invention may be used as a magnetic or nonmagnetic single-component developer, or may also be used as a two-component developer by mixing with a carrier. When the toner is used as a single-component developer, a nonmagnetic single-component developer and a magnetic single-component developer which contains magnetic particles of roughly 0.1-0.5 μm in the toner are provided, and both of them are usable. When the toner is used as a two-component developer, magnetic particles formed of metals such as iron, ferrite or magnetite, or alloys of the foregoing metals with aluminum or lead are usable as a carrier, and of these, ferrite particles are specifically preferable. Further, as the carrier, also used may be a coat carrier in which the magnetic particle surface is coated with a coating agency such as a resin or the like, and a resin dispersion type carrier obtained by dispersing magnetic powder in a binder resin.

The coating resin constituting a coat carrier is not specifically limited, but examples thereof include an olefin based resin, a styrene based resin, a styrene-acryl based resin, an acrylic resin, a silicone based resin, an ester resin, and a fluorine-containing polymer based resin. The resin constituting a resin dispersion type carrier is not specifically limited, and those commonly known are usable. Usable examples thereof include a styrene-acryl based resin, a polyester resin, a fluororesin and a phenol resin.

A coat carrier coated with a styrene-acryl based resin or an acrylic resin as a coating resin is provided as a preferred carrier in view of prevention of external additives from being released, and durability.

The carrier particles preferably have a volume-based median diameter (D₅₀) of 20-100 μm, and more preferably have a volume-based median diameter (D₅₀) of 25-80 μm. The volume-based median diameter (D₅₀) of the carrier particles can be determined employing a laser diffraction type particle size distribution measurement apparatus equipped with a wet disperser (HELOS, produced by SYMPATEC Corp.).

The toner of the present invention can be installed in a monochromatic image forming apparatus or a color image forming apparatus to operate the apparatus.

An image forming apparatus preferably fitted with the toner of the present invention will be described.

### (Image Forming Apparatus)

An image forming apparatus used in the present invention is equipped with at least a charging device to charge the surface of a photoreceptor, an exposure device to expose the charged photoreceptor to light to form an electrostatic latent image; a developing device to develop the electrostatic latent image on the photoreceptor to form a toner image; a primary transfer device to transfer the toner image on the photoreceptor, onto an intermediate transfer member, a secondary transfer device to transfer the toner image having been transferred onto the intermediate transfer member, onto a transfer material; and a device to thermally fix the toner image having been transferred onto the transfer material, on the transfer material, employing a fixing device composed of a heat roller and an applied pressure belt.

Further, in addition to the above-described devices, the image forming apparatus is preferably equipped with a cleaning device to clean the intermediate transfer member, and a coating device to coat a lubricant on the surface of the photoreceptor.

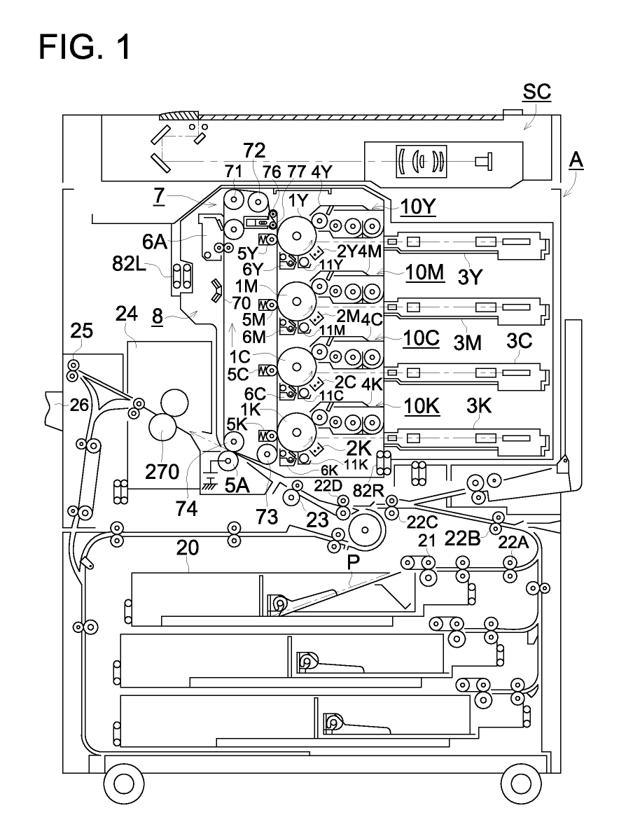

FIG. 1 is a cross-sectional configuration diagram showing an example of an image forming apparatus employing a toner of the present invention.

This image forming apparatus called a tandem type color image forming apparatus comprises a plurality of image forming sections 10Y, 10M, 10C, and 10K, endless-belt-shaped intermediate transfer body unit 7, endless-belt-shaped sheet convey device 21 to convey transfer P, and fixing device 24 composed of a heat roller and an applied pressure belt as a fixing means. Document image reading device SC is placed on the upper portion of main body A of the image forming apparatus.

Image forming section 10Y forming the yellow image as one toner image out of different colors formed on each photoreceptor comprises drum-shaped photoreceptor 1Y as the first image carrier, charging device 2Y placed around the photoreceptor 1Y, exposure device 3Y, developing device 4Y, primary transfer roller 5Y as a primary transfer device, and cleaning device 6Y Image forming section 10M forming the magenta image as one toner image of another different color comprises drum-shaped photoreceptor 1M as the first image carrier, charging device 2M placed around the photoreceptor 1M, exposure device 3M, developing device 4M, primary transfer roll 5M as a primary transfer device, and cleaning device 6M. Image forming section 10C forming the cyan image further as one toner image of another different color comprises drum-shaped photoreceptor 1C as the first image carrier, charging device 2C placed around the photoreceptor 1C, exposure device 3C, developing device 4C, primary transfer roll SC as a primary transfer device, and cleaning device 6C. Image forming section 10K forming the black image further as one toner image of another different color comprises drum-shaped photoreceptor 1K as the first image carrier, charging device 2K placed around the photoreceptor 1K, exposure device 3K, developing device 4K, primary transfer roller 5K as a primary transfer device, and cleaning device 6K.

Endless-belt-shaped intermediate transfer body unit 7 is windingly wound with a plurality of rolls, and has endless-belt-shaped intermediate transfer member 70 as an intermediate transfer endless-belt-shaped second image carrier arranged to be supported and capable of rotation.

Color images formed by image forming sections 10Y, 10M, 10C, and 10K each are sequentially transferred onto rotating endless-belt-shaped intermediate transfer member 70 by primary transfer rollers 5Y, 5M, 5C, and 5K so that a composite color image is formed. Transfer material P stored in sheet feeding cassette 20 is fed by sheet feeding device 21, conveyed to secondary transfer roll 5A as a secondary transfer device through a plurality of intermediate rollers 22A, 22B, 22C, 22D, and registration roller 23, and then, the color image is secondarily transferred onto transfer material P all at once. Transfer material P, on which the color image has been transferred, is fixed with fixing device 24 composed of a heat roller and an applied pressure belt, sandwiched by paper-ejection roll 25, and mounted on paper-ejection tray 26 outside the machine.

On the other hand, after the color image has been transferred onto transfer material P by secondary transfer roller 5A, residual toner is removed from endless-belt-shaped intermediate transfer member 70, from which transfer material P has self-striped, with cleaning device 6A.

In this way, toner images are formed on photoreceptors 1Y, 1M, 1C and 1K via electrification, exposure and development, toner images of each color are superimposed on endless-belt-shaped intermediate transfer member 70 to be transferred onto transfer material. P all at once, and to be subsequently fixed via applied pressure and heat with fixing device 24 composed of a heat roller and an applied pressure belt. As to photoreceptors 1Y, 1M, 1C and 1K after transferring toner images into endless-belt-shaped intermediate transfer member 70, toner remaining on the photoreceptors is cleaned during transfer employing cleaning devices 6A, 6M, 6C and 6K, and a cycle of the above-described electrification, exposure and development is subsequently carried out to conduct the next image formation.

### Example

Embodiments of the present invention are specifically described, but the present invention is not limited to these embodiments.

### <<Preparation of Toner>>

First, a dispersion of metal fluoride was prepared.

### <Preparation of Metal Fluoride Dispersion>

### (Preparation of Metal Fluoride Dispersion 1)

Thirty parts by weight of a surfactant polyoxyethylene (2) sodium dodecylether sulfate were dissolved in 2500 parts by weight of deionized water. While stirring this solution, 150 parts by weight of magnesium fluoride (MgF₂) were added into it, and the system was subsequently subjected to a circulation dispersion treatment at a flow rate of 1 kg/min for 5 hours employing a disperser “SC mill” (manufactured by Mitsui Mining Co., Ltd.) to prepare “metal fluoride dispersion 1”. A measured value of a number average particle diameter of magnesium fluoride particles in this “metal fluoride dispersion 1”, employing an electrophoretic light scattering photometer “ELS-800” (manufactured by Otsuka Electronics Co., Ltd.), was 100 nm.

### (Preparation of Metal Fluoride Dispersion 2)

“Metal fluoride dispersion 2” was prepared similarly to preparation of metal fluoride dispersion 1, except that magnesium fluoride used in the preparation of metal fluoride dispersion 1 was replaced by calcium fluoride (CaF₂). Calcium fluoride particles in this “metal fluoride dispersion 2” had a number average particle diameter of 110 nm.

### (Preparation of Metal Fluoride Dispersion 3)

“Metal fluoride dispersion 3” was prepared similarly to preparation of metal fluoride dispersion 1, except that magnesium fluoride used in the preparation of metal fluoride dispersion 1 was replaced by aluminum fluoride (AlF₃). Aluminum fluoride particles in this “metal fluoride dispersion 3” had a number average particle diameter of 100 nm.

### <Preparation of Toner 1>

### (Preparation of Colorant Dispersion 1)

In 1600 parts by weight of deionized water, dissolved were 90 parts by weight of sodium dodecylsulfate while stirring. Into the resulting solution, gradually added were 420 parts by weight of carbon black (Regal 330R, produced by Cabot Co.) while stirring this solution, and subsequently, the resulting solution was dispersed employing a stirrer “CLEARMIX” (manufactured by M-Technique Co., Ltd.) to prepare a colorant particle dispersion. This is designated as “colorant dispersion 1”. (Preparation of core resin particle 1) The first stage polymerization

In a reaction vessel equipped with a stirrer, a temperature sensor, a condenser and a nitrogen gas introducing device, charged were 4 parts by weight of polyoxyethylene (2) sodium dodecylether sulfate and 3000 parts by weight of deionized water, and the internal temperature was raised to 80° C., while stirring at a stirring speed of 230 rpm under a nitrogen gas stream. After raised to the said temperature, a solution in which 10 parts by weight of potassium persulfate were dissolved in 200 parts by weight of deionized water was added, and the liquid temperature was set to 75° C. After dropping the mixture solution containing the following monomer spending one hour, the system was heated at 75° C. for 2 hours while stirring to conduct polymerization. Thus, resin particles were prepared. This is designated as “resin particle (1A)”.

The mixture solution containing the monomer

| | |
|---|---|
| Styrene | 532 parts by weight |
| n-butyl acrylate | 200 parts by weight |
| Methacrylic acid | 68 parts by weight |
| n-octylmercaptan | 16 parts by weight |

### The Second Stage Polymerization

The mixture solution containing the following monomer was heated at 80° C. while stirring, and 170 parts by weight of paraffin wax having a melting point of 73° C. were dissolved in this mixture solution to prepare a wax-containing monomer mixture solution.

The mixture solution containing the monomer

| | |
|---|---|
| Styrene | 180 parts by weight |
| n-butyl acrylate | 110 parts by weight |
| Methacrylic acid | 20 parts by weight |
| n-octylmercaptan | 3 parts by weight |

In a reaction vessel equipped with a stirrer, a temperature sensor, a condenser and a nitrogen gas introducing device, charged was a solution in which 2 parts by weight of polyoxyethylene (2) sodium dodecylether sulfate were dissolved in 3000 parts by weight of deionized water, followed by heating to 80° C. Subsequently, 52 parts by weight of the foregoing resin particle (1A) in solid content conversion and the foregoing wax-containing monomer mixture solution were added, and dispersed for one hour employing a mechanical stirrer “CLEARMIX” (manufactured by M-Technique Co., Ltd.) fitted with a circular flow path to prepare a dispersion containing emulsified particles (oil droplets).

Subsequently, into this dispersion, added was an initiator solution in which 5 parts by weight of potassium persulfate were dissolved in 100 parts by weight of deionized water, and this system was heated at 80° C. while stirring spending one hour to conduct polymerization. This is designated as “resin particle (1B)”.

### The Third Stage Polymerization

Further, a solution in which 10 parts by weight of potassium persulfate were dissolved in 200 parts by weight of deionized water was added, and a monomer formed from those described below was dropped at 80° C. spending one hour. After completion of dropping, heating while stirring was carried out for 2 hours to conduct polymerization, followed by cooling down to 28° C. to obtain resin particles. This is designated as “core resin particle 1”.

| | |
|---|---|
| Styrene | 390 parts by weight |
| n-butyl acrylate | 235 parts by weight |
| Methacrylic acid | 44 parts by weight |
| n-octylmercaptan | 10 parts by weight |

### (Preparation of Shell Resin Particle 1)

In a reaction vessel equipped with a stirrer, a temperature sensor, a condenser and a nitrogen gas introducing device, charged were 1.7 parts by weight of sodium dodecy sulfate and 3000 parts by weight of deionized water, and the internal temperature was raised to 80° C., while stirring at a stirring speed of 230 rpm under a nitrogen gas stream. After raised to the said temperature, a solution in which 10 parts by weight of potassium persulfate were dissolved in 200 parts by weight of deionized water was added, and the liquid temperature was set to 80° C. After dropping the mixture solution containing the following monomer spending 2 hours, the system was heated at 80° C. for 2 hours while stirring to conduct polymerization. Thus, resin particles were prepared. This is designated as “shell resin particle 1”.

| | |
|---|---|
| Styrene | 660 parts by weight |
| n-buryl acrylate | 120 parts by weight |
| Methacrylic acid | 60 parts by weight |
| n-octylmercaptan | 22 parts by weight |

### (Coagulating/Fusing Step)

Into a reaction vessel equipped with a stirrer, a temperature sensor, a condenser and a nitrogen gas introducing device, charged were 392 parts by weight of “core resin particle 1” in solid content conversion, 1100 parts by weight of deionized water, and 200 parts by weight of “colorant dispersion 1”, and after adjusting to a liquid temperature of 30° C., 5N of an aqueous sodium hydroxide solution were added to adjust a pH to 10. Subsequently, an aqueous solution in which 60 parts by weight of magnesium chloride were dissolved in 60 parts by weight of deionized water was added thereto at 30° C. spending 10 minutes while stirring. After standing for 3 min., the temperature of this system was raised up to 80° C. spending 60 minutes, and maintained at 80° C. to continuously promote particle growth reaction. The associated particle diameter was measured in this situation, employing “COULTER MULTICIZER 3”, and when the volume-based median particle diameter reached 6 μm, an aqueous solution in which 40 parts by weight of sodium chloride were dissolved in 160 parts by weight of deionized water was added thereto to terminate particle growth. Further, as a ripening step, heating is conducted at a liquid temperature of 80° C. while stirring spending one hour to promote fusion of particle-to-panicle. Thus, “core particle 1” was formed.

### (Shelling Step)

Next, 44 parts by weight of “shell resin particle 1” in solid content conversion, and 14.8 parts by weight of “metal fluoride dispersion 1” in solid content conversion were added at the same time, followed by continuously stirring at 80° C. for 2 hours, and “shell resin particle 1” was fused on “core particle 1” while taking “metal fluoride” in to form a shall layer. An aqueous solution in which 150 parts by weight of sodium chloride were dissolved in 600 parts by weight of deionized water was subsequently added to conduct a ripening treatment, and the system was cooled to 30° C. when reaching the intended circularity to prepare toner mother particles each having a core/shell structure.

### (Washing/Drying Step)

The toner particles prepared as described above were subjected to solid/liquid separation employing a basket type centrifugal separator to form a wet cake of toner mother particles. This wet cake was washed with 40° C. deionized water employing the forgoing basket type centrifugal separator until the filtrate reached an electric conductivity of 5 μS/cm, transferred to Flash Jet Dryer (produced by Seishin Enterprise Co., Ltd.) and dried until reaching a moisture content of 0.5% by weight to prepare “toner mother particle 1”.

### (External Additive Treatment Step)

Into toner mother particle 1 prepared as described above, added were 1% by weight of hydrophobic silica (a number average primary particle diameter of 12 nm) and 0.3% by weight of hydrophobic titania (a number average primary particle diameter of 20 nm), and the system was mixed with a Henschel mixer to prepare “toner 1”.

### <Preparation of Toners 2-4, 9, and 10>

“Toners 2-4, 9, and 10” were prepared similarly to preparation of toner 1, except that an addition amount of “metal fluoride dispersion 1” in the shelling step was replaced by those described in Table 1.

### <Preparation of Toner 5>

“Toner 5” was prepared similarly to preparation of toner 1, except that “metal fluoride dispersion 1 (MgF₂)” in the shelling step was replaced by 25.1 parts by weight of “metal fluoride dispersion 2 (CaF₂) in solid content conversion”.

### <Preparation of Toner 6>

“Toner 6” was prepared similarly to preparation of toner 1, except that “metal fluoride dispersion 1 (MgF₂)” in the shelling step was replaced by 25.1 parts by weight of “metal fluoride dispersion 3 (AlF₃) in solid content conversion”.

### <Preparation of Toner 7>

### (Coagulating/Fusing Step)

Into a reaction vessel equipped with a stirrer, a temperature sensor, a condenser and a nitrogen gas introducing device, charged were 392 parts by weight of “core resin particle 1” in solid content conversion, 25.1 parts by weight of “metal fluoride dispersion 1” in solid content conversion, 1100 parts by weight of deionized water, and 200 parts by weight of “colorant dispersion 1”, and after adjusting to a liquid temperature of 30° C., 5N of an aqueous sodium hydroxide solution were added to adjust a pH to 10. Subsequently, an aqueous solution in which 60 parts by weight of magnesium chloride were dissolved in 60 parts by weight of deionized water was added thereto at 30° C. spending 10 minutes while stirring. After standing for 3 min., the temperature of this system was raised up to 80° C. spending 60 minutes, and maintained at 80° C. to continuously promote particle growth reaction. The associated particle diameter was measured in this situation, employing “COULTER MULTICIZER 3”, and when the volume-based median particle diameter reached 6 μm, an aqueous solution in which 40 parts by weight of sodium chloride were dissolved in 160 parts by weight of deionized water was added thereto to terminate particle growth. Further, as a ripening step, heating is conducted at a liquid temperature of 80° C. while stirring spending one hour to promote fusion of particle-to-particle. Thus, “core particle 7” was formed.

### (Shelling Step)

Next, 44 parts by weight of “shell resin particle 1” in solid content conversion was added, followed by continuously stirring at 80° C. for 2 hours, and “shell resin particle 1” was fused on “core particle 7” to form a shall layer. An aqueous solution in which 150 parts by weight of sodium chloride were dissolved in 600 parts by weight of deionized water was subsequently added to conduct a ripening treatment, and the system was cooled to 30° C. when reaching the intended circularity.

### (Washing/Drying Step)

The resulting toner particles were subjected to solid/liquid separation employing a basket type centrifugal separator to form a wet cake of toner mother particles. This wet cake was washed with 40° C. deionized water employing the forgoing basket type centrifugal separator until the filtrate reached an electric conductivity of 5 μS/cm, transferred to Flash Jet Dryer (produced by Seishin Enterprise Co., Ltd.) and dried until reaching a moisture content of 0.5% by weight to prepare “toner mother particle 7”.

### (External Additive Treatment Step)

Into toner mother particles prepared as described above, added were 1% by weight of hydrophobic silica (a number average primary particle diameter of 12 nm) and 0.3% by weight of hydrophobic titania (a number average primary particle diameter of 20 nm), and the system was mixed with a Henschel mixer to prepare “toner 7”.

### <Preparation of Toner 8>

After the following substances were sufficiently mixed with “Henschel mixer” manufactured by Mitsui Mining Co., Ltd., the mixture was melt-kneaded with a twin-screw extruding kneader PCM (manufactured by Ikegai Corporation), followed by rapidly cooling, and the system was coarsely pulverized with “Feather Mill” (manufactured by Hosokawa Micron Corporation).

Next, the coarsely pulverized product was pulverized with a jet mill (IDS, manufactured by Nippon Pneumatic Mfg. Co. Ltd.), and the resulting was classified with a classifier “Turboplex” (manufactured by Hosokawa Micron Corporation) to prepare “toner mother particle 8” having a volume-based median particle diameter (D₅₀) of 6.4 μm.

| | |
|---|---|
| Polyester resin (a glass transition point | 400 parts by weight |
| of 62° C. and a softening point of 110° C.) | |
| Carbon black (Mogal L, produced by Cabot | 32 parts by weight |
| Corp.) | |
| Polyethylene wax (a melting point of 89° C.) | 12 parts by weight |
| Metal fluoride (MgF₂) | 23.4 parts by weight |

### (External Additive Treatment Step)

Into toner mother particle 8 prepared as described above, added were 1% by weight of hydrophobic silica (a number average primary particle diameter of 12 nm) and 0.3% by weight of hydrophobic titania (a number average primary particle diameter of 20 nm), and the system was mixed with a Henschel mixer to prepare “toner 8”.

“Toner 11” was prepared similarly to preparation of toner 1, except that metal fluoride dispersion 1 added in the shelling step was not added.

The preparation method of each of toners 1-11, the portion containing metal fluoride, the kinds and addition amounts parts by weight) of utilized metal fluorides, and the content in toner particles (% by weight) are shown in Table 1.

TABLE 1

| | | Portion | | | Addition | Content in |
|---|---|---|---|---|---|---|
| | | containing | | | amount | toner |
| Toner | Preparation | metal | Metal fluoride | | (Parts by | particles |
| No. | method | fluoride | | Compound | weight) | (% by weight) |
| Toner | Polymerization | Shell | Metal | MgF₂ | 14.8 | 3 |
| 1 | method | layer | fluoride | | | |
| | | | dispersion 1 | | | |
| Toner | Polymerization | Shell | Metal | MgF₂ | 25.1 | 5 |
| 2 | method | layer | fluoride | | | |
| | | | dispersion 1 | | | |
| Toner | Polymerization | Shell | Metal | MgF₂ | 35.8 | 7 |
| 3 | method | layer | fluoride | | | |
| | | | dispersion 1 | | | |
| Toner | Polymerization | Shell | Metal | MgF₂ | 52.8 | 10 |
| 4 | method | layer | fluoride | | | |
| | | | dispersion 1 | | | |
| Toner | Polymerization | Shell | Metal | CaF₂ | 25.1 | 5 |
| 5 | method | layer | fluoride | | | |
| | | | dispersion 2 | | | |
| Toner | Polymerization | Shell | Metal | AlF₃ | 25.1 | 5 |
| 6 | method | layer | fluoride | | | |
| | | | dispersion 3 | | | |
| Toner | Polymerization | Core | Metal | MgF₂ | 25.1 | 5 |
| 7 | method | portion | fluoride | | | |
| | | | dispersion 1 | | | |
| Toner | Pulverization | Entire | Metal | MgF₂ | 23.4 | 5 |
| 8 | method | portion | fluoride | | | |
| Toner | Polymerization | Shell | Metal | MgF₂ | 4.8 | 1 |
| 9 | method | layer | fluoride | | | |
| | | | dispersion 1 | | | |
| Toner | Polymerization | Shell | Metal | MgF₂ | 64.9 | 12 |
| 10 | method | layer | fluoride | | | |
| | | | dispersion 1 | | | |
| Toner | Polymerization | None | — | — | — | — |
| 11 | method | | | | | |

### <<Preparation of Developer>>

In a high-speed mixer equipped with stirring blades, charged were 100 parts by weight of ferrite core and 5 parts by weight of copolymer resin particles formed from cyclohexylmethacrylate/methylmethacrylate (a copolymerization ratio of 5/5), followed by mixing while stirring at 120° C. for 30 minutes to form a resin coat layer on the ferrite core surface via action of mechanical impact force, and then to obtain a carrier having a volume-based median particle diameter of 50 μm.

The volume-based median particle diameter of carrier was measured employing a laser diffraction type particle size distribution measuring apparatus (HELOS, manufactured by SYMPA IEC Co.) equipped with a wet-type homogenizer.

Each of “Toners 1-11” was added into the above-described carrier so as to give a toner content of 6% by weight, and mixed at rotation speed of 45 rpm for 30 minutes employing a micro type V-shaped mixer (manufactured by Tsutsui Scientific Instruments Co., Ltd. to prepare “developers 1-11”

### <<Image Evaluation>>

The resulting toner described above and a developer were sequentially placed in a digital color complex machine “Bizhub PRO C500, manufactured by Konica Minolta Business Technologies, Inc”, and after printing 300,000 paper sheets as A-4 size fine-quality paper sheets (a basis weight of 64 g/m²) at high temperature and high humidity (30° C. and 85% RH), the complex machine was stored in the environment for 36 hours.

Thereafter, a solid image was printed on the fine-quality paper (a basis weight of 64 g/m²) at high temperature and high humidity (30° C. and 85% RH), followed by a halftone image to be printed on the fine-quality paper (a basis weight of 64 g/m²) at high temperature and high humidity (30° C. and 85% RH).

### (Solid Image Density)

As to the solid image density, relative reflection density of a printing image with respect to a white paper sheet was measured at five points of the central portion and four corners in total, and evaluated in mean value. The density of solid image was measured employing “Macbeth RD918” (manufactured by Macbeth Co.). An image density of 1.20 or more was determined as one at a level of no practical problem.

### (Halftone Image Unevenness)

As to the halftone image unevenness, relative reflection density of the halftone image with respect to a white paper sheet was measured at five points in the axis direction of a photoreceptor, and was evaluated. The density of halftone image was measured employing “Macbeth RD918” (manufactured by Macbeth Co.).

The evaluations of halftone image unevenness were determined by density difference in halftone image (ΔHD=maximum density−minimum density). A density difference of 0.10 or less was determined as one at a level of no practical problem.

Evaluation results are shown in Table 2.

TABLE 2

| | | Image evaluation | |
|---|---|---|---|
| | Toner | Solid image | Halftone image |
| | No. | density | unevenness |
| Example 1 | Toner 1 | 1.23 | 0.06 |
| Example 2 | Toner 2 | 1.28 | 0.03 |
| Example 3 | Toner 3 | 1.30 | 0.01 |
| Example 4 | Toner 4 | 1.33 | 0.04 |
| Example 5 | Toner 5 | 1.28 | 0.05 |
| Example 6 | Toner 6 | 1.27 | 0.04 |
| Example 7 | Toner 7 | 1.21 | 0.06 |
| Example 8 | Toner 8 | 1.25 | 0.05 |
| Comparative example 1 | Toner 9 | 1.14 | 0.12 |
| Comparative example 2 | Toner 10 | 1.22 | 0.13 |
| Comparative example 3 | Toner 11 | 1.14 | 0.12 |

As is clear from Table 2, it is to be understood that each of Examples 1-8 of the present invention produces no problem in all the evaluation items. On the other hand, it is to be understood that each of Comparative examples 1-3 produces a problem in any of the evaluation items, and the object of the present invention has not been accomplished.

### EFFECT OF THE INVENTION

The electrostatic charge image developing toner of the present invention (hereinafter, also referred to simply as toner) produces an excellent effect exhibiting neither halftone image unevenness nor density drop of solid images, even though a large number of print sheets are printed at high temperature and high humidity, and subsequently printing is further carried out at high temperature and high humidity after standing for a long time.

What is claimed is:

1. An electrostatic charge image developing toner comprising 3-10% by weight of at least one metal fluoride selected from the group consisting of sodium fluoride, magnesium fluoride, calcium fluoride, barium fluoride and aluminum fluoride, based on a total weight of the toner.

2. The electrostatic charge image developing toner of claim 1, comprising a toner formed via coagulation/fusion of at least a resin in an aqueous medium.

3. The electrostatic charge image developing toner of claim 1, comprising a core/shell structure comprising a core portion and a shell layer.
wherein the shell layer comprises the metal fluoride.

4. The electrostatic charge image developing toner of claim 1,
wherein external additives in the toner have an addition amount of 0.05-5 parts by weight, with respect to 100 parts by weight of the toner.

5. The electrostatic charge image developing toner of claim 1,
wherein external additives in the toner have an addition amount of 0.1-3 parts by weight, with respect to 100 parts by weight of the toner.

6. The electrostatic charge image developing toner of claim 1,
wherein the at least one metal fluoride is magnesium fluoride or calcium fluoride.

7. The electrostatic charge image developing toner of claim 1,
wherein the at least one metal fluoride has a content of 4-7% by weight, based on the total weight of the toner.
